(19) United States
(12) Patent Application Publication
(10) Pub. No.: US 2017/0031045 A1
(43) Pub. Date: Feb. 2, 2017

(54) METHOD AND APPARATUS FOR MODELING AND SEPARATION OF PRIMARIES AND MULTIPLES USING MULTI-ORDER GREEN'S FUNCTION

(71) Applicant: CGG SERVICES SA, Massy Cedex (FR)

(72) Inventors: Gordon POOLE, East Grinstead (GB); Richard WOMBELL, Crawley (GB); James COOPER, Redhill, Surrey (GB)

(21) Appl. No.: 15/303,266

(22) PCT Filed: Apr. 14, 2015
(86) PCT No.: PCT/IB2015/000784

§ 371 Date: Oct. 11, 2016

Related U.S. Application Data
(60) Provisional application No. 62/091,128, filed on Dec. 12, 2014.
(60) Provisional application No. 61/979,356, filed on Apr. 14, 2014.

(51) Int. Cl. G01V 1/36; G01V 1/28

(52) U.S. Cl. CPC G01V 1/364; G01V 1/282; G01V 2210/675; G01V 2210/56; G01V 2210/57

(57) ABSTRACT

Data is recorded by sensors while an underground formation is explored, e.g., using a seismic acquisition system that emits and receives waves. A model, which is indicative of primary waves contained in the received data, is derived using a multi-order Green's function. Using the model, an image of the underground formation is generated.

### CROSS REFERENCE TO RELATED APPLICATIONS

This application claims priority and benefit from U.S. Provisional Patent Application No. 61/979,356, filed Apr. 14, 2014, for “Technique for Demultiple Using Combined Recursive Multiple Modeling” and from U.S. Provisional Patent Application No. 62/091,128, filed Dec. 12, 2014, also for “Technique for Demultiple Using Combined Recursive Multiple Modeling”, the entire content of both applications being incorporated in their entirety herein by reference.

### BACKGROUND

Technical Field

Embodiments of the subject matter disclosed herein generally relate to processing seismic data using a subsurface model. More specific, primaries and multiple reflections are modeled and separated as part of a process for generating an image of the subsurface.

Discussion of the Background

Hydrocarbon exploration and development uses waves (e.g., seismic waves or electromagnetic waves) to explore the structure of underground formations on land and at sea (i.e., formations under the seafloor). As schematically illustrated in FIG. 1, waves emitted by a source 110 at a known location penetrate an explored formation 120 and are reflected at interfaces 122, 124, 126 that separate the formation's layers having different layer impedances. Sensors 130 detect the reflected waves. The detected waves include primary reflections such as wave 140 which travels directly from a formation interface to a sensor, and multiple reflections such as wave 150, which are reflected at least one additional time inside the formation before being detected. Note that, as used herein, the term “formation” refers to any geophysical structure into which source energy is promulgated to perform seismic surveying, e.g., land or water based, such that a “formation” will include a water layer when the context is marine seismic surveying.

There are various types of multiples, e.g., surface-related multiples and interbed multiples. In the case of surface-related multiples, when the energy reflected from the subsurface reaches the water surface it will be reflected back downwards into the water column and subsurface. This produces a second set of reflected energy containing spurious events. Lnterbed multiples are similar, but in this case the downward reflecting surface is a rock interface in the subsurface.

Moreover, multiples can be characterized as belonging to different orders, e.g., first order, second order, third order, etc., based on the number of additional reflections involved. For example, a primary has a single reflection between a source S and a receiver R as shown in FIG. 2(a). By way of contrast a first order multiple (shown in FIG. 2(b)) can have two additional reflections relative to the primary, whereas a second order multiple (shown in FIG. 2(c)) can have four additional reflections.

In order to understand the structure of the explored underground formation, it is preferable that primaries and multiples be separated as part of the processing of the recorded seismic data, and frequently it is preferable to remove the multiples. Accordingly, there are also numerous processing techniques which have been developed to attenuate or suppress multiples in the recorded seismic data. These include, just to name a few, Radon demultiple, surface-related multiple elimination (SRME), deconvolution, Green's function modelling and inverse scattering. As will be appreciated by those skilled in the art, each of these techniques has its strengths and weaknesses. The interested reader is directed to the book entitled “Seismic Multiple Removal Techniques: Past, Present and Future”, by D. J. Verschuur, published by EAGE publications in 2006 for more information regarding these techniques.

The success of surface-related multiple attenuation in shallow water environments is limited by an absence of near offsets and a lack of high quality water bottom primary reflections in the recorded data. Together with amplitude errors arising from cross-talk between multiples (for example relating to convolution of recorded data with itself rather than recorded data and primary as theoretically required by SRME) these factors have been cited as causing the breakdown of SRME in shallow water. As an alternative, a traditional approach such as 1D predictive deconvolution in the τ-p domain can be used with some success, but this method is compromised by the assumption of a 1D multiple generator, and erroneous attenuation of primary reflections with a period similar to that of the multiple generator. Modern strategies include the use of multi-channel prediction operators to model water bottom primary reflections directly from Water-Layer Related Multiples (WLRMs) present in the recorded data. A Water-Layer Related Multiple is typically defined to be any multiple involving at least one upgoing reflection from the sea floor travelling through the water layer. This reduces the impact of the missing near offsets and the poorly recorded water bottom primary, but the data-derived prediction operators are susceptible to contamination by noise and other events unrelated to the WLRMs. It is also possible to model multiples with this approach for events just below the waterbottom or more generally for a given reflectivity section, see, e.g., Pica, A., Poulain, G., David, B., Magesan, M., Baldock, S., Weisser, T., Hugonnet, P., and Herrmann, P., 2005, 3D surface-related multiple modelling, FACE conference proceedings.

Recently, Wang et al. proposed a Model-based Water-Layer Demultiple (MWD) approach to estimate WLRMs based on a Green's function derived from a known water depth in their article “Model-based water-layer demultiple”, 81^{st} Annual International Meeting SEG, Expanded Abstracts, pp. 3551-3555 (2011), the disclosure of which is incorporated here by reference. In this context, a Green's function can be defined to be an impulse response for a point source located at the sea floor, propagating through the water layer with a known velocity. The Green's function may contain some reflectivity information, but in general this will not be the case. With a sufficiently accurate Green's function, the MWD method gives rise to a model predicting the timing of the multiples with a high degree of accuracy.

While the MWD method accurately predicts the timing of multiples, it does so with errors regarding the amplitude of those multiples having an order greater than one. This amplitude problem is described in more detail below. Accordingly, it remains desirable to develop systems and techniques for identifying and removing multiples, generally, and also to address this particular amplitude issue with the MWD technique.

### SUMMARY

In some embodiments, multi-order Green's functions are used to model and separate primaries and multiple reflections.

According to one embodiment, there is a method for processing data recorded by sensors while exploring an underground formation using waves. A model is derived, which is indicative of primary waves contained in the received data, using a multi-order Green's function. An image of the underground formation is generated using the model.

According to another embodiment, there is a method for processing data recorded by sensors while an underground formation is explored using waves. A primary estimate of the data is determined simultaneously using re-multiple and re-ghosting operators. The primary estimate is used to attenuate ghost energy in the data. An image of the underground formation is generated using the de-ghosted data.

According to another embodiment, a data processing apparatus includes an interface configured to receive data recorded by sensors while an underground formation is explored using waves; and a data processing unit configured to derive a model, which is indicative of primary waves contained in the received data, using a multi-order Green's function; and to generate an image of the underground formation using the model.

According to another embodiment, a data processing apparatus includes an interface configured to receive data recorded by sensors while an underground formation is explored using waves; and a data processing unit configured to determine a primary estimate of the data simultaneously using re-multiple and re-ghosting operators, to use the primary estimate to attenuate ghost energy in the data, and to generate an image of the underground formation using the de-ghosted data.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic illustration of exploring underground formations using waves including a primary and a multiple;

FIGS. 2(a)-2(c) illustrate a primary, a source side peg-leg multiple, and a receiver side peg-leg multiple, respectively;

FIG. 3 shows actual amplitude terms of multiples taken directly from seismic data;

FIG. 4 shows predicted amplitude terms of multiples for the same seismic data as in FIG. 3 which were predicted using a Model-based Water-Layer Demultiple (MWD) approach;

FIG. 5 illustrates a fifth order multiple;

FIG. 6 is a flow chart showing a method for processing seismic data according to an embodiment;

FIG. 7 is a flow chart showing a method for processing seismic data according to another embodiment;

FIG. 8 show multiples involved in a marine seismic acquisition using a variable depth streamer;

FIG. 9 is a flow chart showing a method for processing seismic data according to another embodiment;

FIG. 10 is a schematic diagram of a data processing apparatus according to an embodiment; and

FIGS. 11-13 are flow charts depicting methods according to other embodiments.

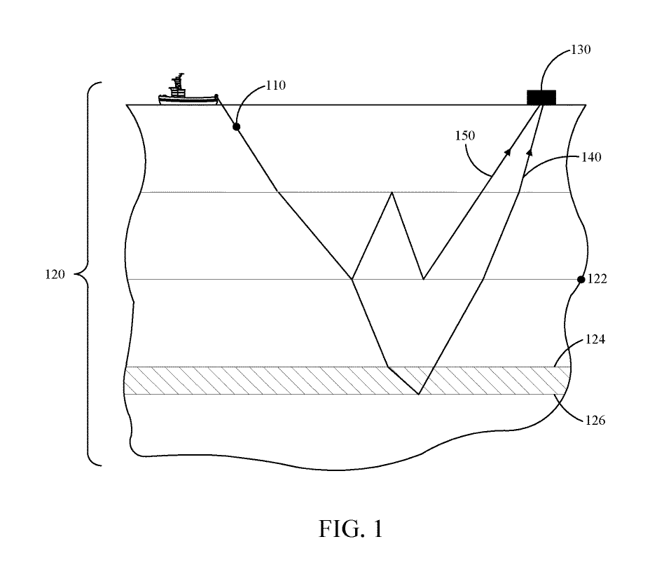

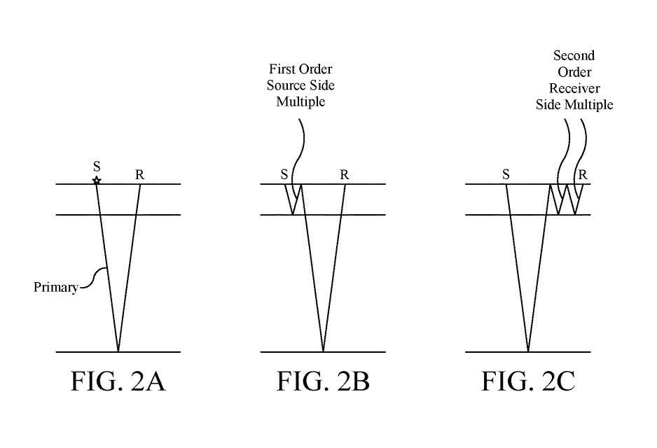

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed using terminology of seismic data processing. However, the described methods may be used for other wave data processing (e.g., electro-magnetic wave data).

Reference throughout the specification to “one embodiment” or “an embodiment” means that a particular feature, structure or characteristic described in connection with an embodiment is included in at least one embodiment of the subject matter disclosed. Thus, the appearance of phrases in “one embodiment” or in “an embodiment” in various places throughout the specification is not necessarily referring to the same embodiment. Further, the particular features, structures or characteristics may be combined in any suitable manner in one or more embodiments.

As mentioned in the Background, one problem associated with using the MWD technique to attenuate multiples in received seismic data is that it tends to overestimate the amplitude of multiples of order two or higher. According to an embodiment, this amplitude problem can be corrected by, for example, first generating a MWD model for only the receiver-side Green's function and then using that model as the input to a second MWD modelling process which is for only the source-side Green's function. To better understand this embodiment, first the problem and then the solution will now be described in more detail.

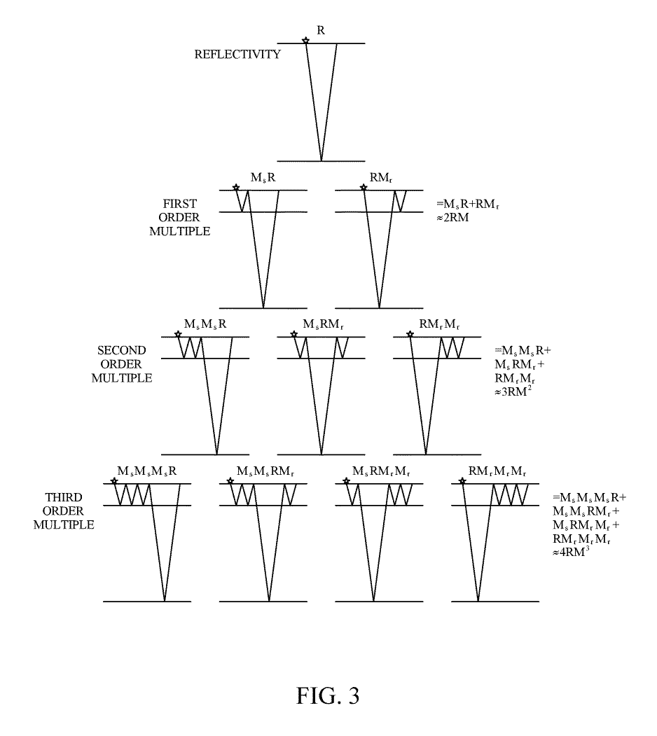

The amplitude overestimation which occurs as the result of a conventional MWD process can be seen by comparing the amplitudes of multiples actually found in recorded data to the amplitudes which are predicted by the MWD process. Referring now to FIG. 3, several orders of peg-leg multiples are found in the recorded data. Therein R is the deep reflectivity (primary), Mₛ is the reflectivity of the source side peg leg multiple generator, and Mᵣ is the reflectivity of the receiver side peg leg multiple generator. For the sake of this example, and since in some shallow water environments this is true, it is assumed that the depths and reflectivities of the source and receiver side peg leg multiple generators are the same, so that Mₛ=Mᵣ=M. This leads to a series approximation term for the amplitude of each different order of multiple which is illustrated to the right of those multiples in FIG. 3 and which can be summed as:

R+2RM+3RM²+4RM³+ . . . +(n+1)RMⁿ (1)

Each term in equation (1) and FIG. 3 can be derived from the following one dimensional geometrical argument: For a multiple of order ‘n’, there are ‘n+1’ different permutations of distributing the ‘n’ multiple ‘legs’ about the primary event (on the source side or the receiver side of the event). This can be seen from FIG. 3. Each of these different permutations will appear once in the recorded data, as a physical ray path. Based on the assumption that the sea floor is flat with constant reflectivity, the timing and amplitude of each permutation will be the same, so the overall amplitude is governed by the additive effect of these n+1 paths. This yields the (n+1) coefficient in equation (1). The amplitude is modified by a factor, ‘R’, which is used to account for the fact that each path includes a single reflection from the primary event, with reflectivity coefficient R. The amplitude is further modified by a factor ‘Mⁿ’, which is used to account for the fact that each path includes a total of ‘n’ reflections from the sea floor, each with reflectivity ‘M’.

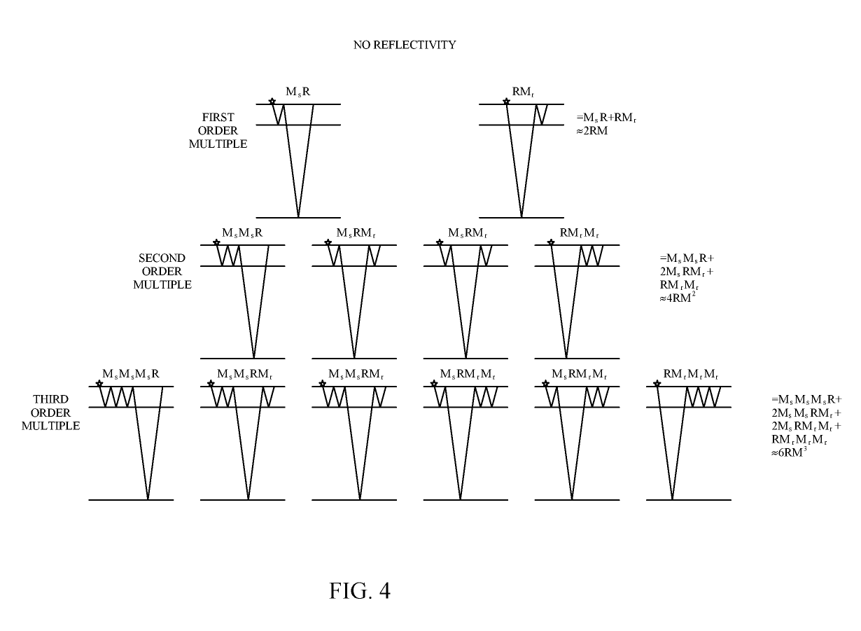

By way of contrast, consider instead if the multiples are predicted using the conventional MWD process as shown graphically in FIG. 4. Therein, the first order predicted multiple comes from the data reflectivity, the second order predicted multiples come from the first order multiples in the data, and the third order predicted multiples come from the second order multiples in the data. This leads to the amplitude series terms found on the right hand side of FIG. 4 which can be summed as:

0+2RM+4RM²+6RM³+ . . . +2nRMⁿ (2)

More specifically, the terms in equation (2) and FIG. 4 can, for example, be derived by the following one dimensional geometrical argument. The MWD technique will model multiples of order n by convolving multiples of order (n−1) in the recorded data with Green's functions on the source or receiver sides. Again, using the assumption of a flat sea floor with constant reflectivity, the amplitude of multiples of order (n−1) in the recorded data will be n*RMⁿ⁻¹. This conclusion is based on the expression derived above with respect to FIG. 3. The convolution with the Green's function generates an additional reflection from the sea floor, so that this amplitude term is modified to n*RMⁿ. Finally, the factor of 2 in the amplitude term is present because the source side convolutions and receiver side convolutions each predict this amplitude of n*RMⁿ; these two are then summed to give the overall amplitude of 2n*RMⁿ

Comparing the coefficients of the series terms in equations (1) and (2) reveals the amplitude errors introduced into higher order multiples by the MWD prediction model. Specifically, while the first order terms have the same amplitude coefficient (i.e., 2), the second order amplitude coefficient is different for the actual value derived from the data (i.e., 3) when compared to the predicted amplitude coefficient (i.e., 4). Errors are also found in the higher order terms.

The preceding discussion is specific to the case where the sea floor is flat and of constant reflectivity, and that the convolutions have been considered in a 1D sense. However note that, from this point forward, the discussion is more general, with no such restriction that the multiple generators must be the same depth, and with the convolutions considered more properly in a multi-dimensional sense (with reference to multiple contribution gathers (MCGs)). The following discussion does, however, continue to assume that the water bottom reflectivity, M, is the same on the source and receiver sides.

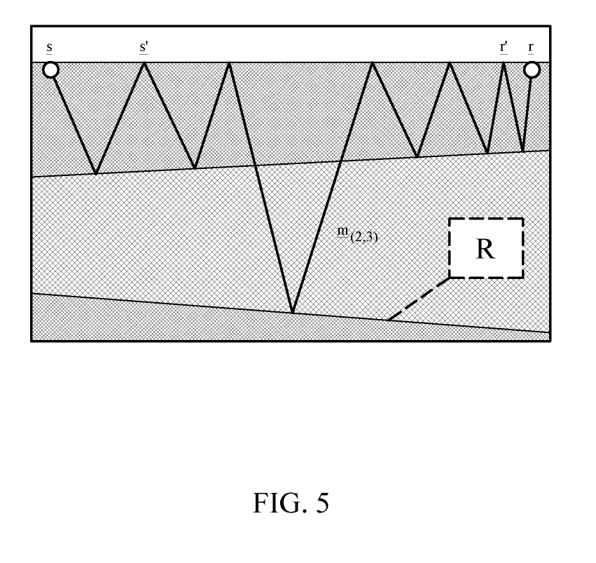

The amplitude error associated with the conventional MWD technique can also be expressed more rigorously. Consider the path, m_{(i,j-i)}, of j^{th} order peg-leg WLRM of some event, R, where i and (j-i) represent the number of water layer reflections on the source and receiver sides respectively. Consider a primary event as a zeroth order multiple (j=0) and denote by s and (the respective positions of the source and receiver corresponding to m_{(i,j-i)}. A schematic example is shown in FIG. 5 for the case i=2, j=5. Further denote by D the recorded data, comprising primary data and all orders of WLRM. The j^{th} order multiples of R corresponding to the source-receiver pair, (s,r), are represented within D by Mⱼ, where

Mⱼ=Σᵢ₌₀^{j}m_{(i,j-i)}(s,r) (3)

The conventional MWD process simultaneously predicts all orders of WLRM by convolving the recorded data, D, with a modelled water layer Green's function, g(a,b), between two surface locations, a and b. Modelling is carried out independently for source-side and receiver-side Green's functions. For illustration, this discussion considers each order of multiple in isolation, and examines how the MWD model for each order is obtained. For j≧1, conventional MWD models j^{th} order multiples by convolving the (j−1)^{th} order multiples in the recorded data with source-side and receiver-side Green's functions, so that the modelled j^{th} order multiple is described by Qⱼ, where

$$\begin{matrix}{\underline{Q}}_{j} = {\sum }_{i = 0}^{j - 1} ( \underline{g} ( \underline{s} , {\underline{s}}^{′} ) ⊗ {\underline{m}}_{( i , j - i - 1 )} ( {\underline{s}}^{′} , \underline{r} ) + {\underline{m}}_{( i , j - i - 1 )} ( \underline{s} , {\underline{r}}^{′} ) ⊗ \underline{g} ( {\underline{r}}^{′} , \underline{r )} ) \\ = α {\sum }_{i = 0}^{j - 1} ( {\underline{m}}_{( i + 1 , j - i - 1 )} ( \underline{s} , \underline{r} ) + {\underline{m}}_{( i , j - i )} ( \underline{s} , \underline{r} ) ) \\ = α {\sum }_{i = 0}^{j} ( {\underline{m}}_{( i , j - i )} ( \underline{s} , \underline{r} ) + α {\sum }_{i = 1}^{j - 1} ( {\underline{m}}_{( i , j - i )} ( \underline{s} , \underline{r} ) \\ = α {\underline{M}}_{j} + α {\sum }_{i = 1}^{j - 1} {\underline{m}}_{( i , j - i )} ( \underline{s} , \underline{r} )\end{matrix} \qquad ( 4 )$$

In equation (4), s′ and r′ (seen in FIG. 5) are source and receiver positions, taken to be the surface locations of the apexes of the multiple contribution gathers (MCGs) associated with the convolutions on the source and receiver sides, respectively. The convolutions are represented by the operator, [symbol] . The MCG can be defined to be a gather comprising convolved pairs of traces relating to a fixed source-receiver pair, such that the sum of these traces represents a multiple model for the single seismic input trace defined by the source-receiver pair. For more information refer to “Seismic Multiple Removal Techniques: Past, Present and Future”, by D. J. Verschuur, published by FACE publications in 2006. In general, the amplitude of the Green's function within an implementation of conventional MWD is taken to be arbitrary. For all orders of multiple, the amplitude of the modelled multiples will be scaled once by this Green's function amplitude. In the recorded data, however, the overall amplitudes of the multiples are driven by the water bottom reflectivity. Accordingly the constant scale factor, α, has been introduced and is implicitly defined so that the constant scaling effects of the arbitrary-amplitude Green's function are represented by α.

The timings of the predicted multiples generated by equation (4) are fully consistent with the recorded data, but their amplitudes are not. But for the constant multiplicative term, α, the final term in equation (4) represents the amplitude error in the modelled multiple from the recorded multiple. In the case of first order multiples (j=1), this error term is zero and the multiples are predicted with the correct amplitude (again, but for the constant scale factor, α). However, the amplitudes of higher order multiples are over-predicted as discussed previously.

According to embodiments which will now be described, this error term is corrected by developing an auxiliary MWD model which itself comprises the error term in equation (4), although with a modified form of the overall scaling constant. Then, this error term can be subtracted from the output of the conventional MWD process.

Consider a multiple model constructed in the following way according to an embodiment. Initially, a conventional MWD model is generated from the recorded data, but for receiver-side Green's functions only. The output from this first MWD modelling process is then used as the input data to a second MWD modelling process, this time for source-side Green's functions only. In this way, for j the order multiples in the resulting model are obtained by convolving (j−2)^{th} order multiples in the data successively with Green's functions on both the source and receiver sides. These order multiples are described by where

$$\begin{matrix}{\underline{E}}_{j} = {\sum }_{i = 0}^{j - 2} ( \underline{g} ( \underline{s} , {\underline{s}}^{′} ) ) ⊗ {\underline{m}}_{( i , j - i - 2 )} ( {\underline{s}}^{′} , {\underline{r}}^{′} ) ⊗ ( \underline{g} ( {\underline{r}}^{′} , \underline{r} ) ) \\ = {α}^{2} {\sum }_{i = 0}^{j - 2} {\underline{m}}_{( i + 1 , j - i - 1 )} ( \underline{s} , \underline{r} ) \\ = {α}^{2} {\sum }_{i = 1}^{j - 1} {\underline{m}}_{( i , j - i )} ( \underline{s} , \underline{r} )\end{matrix} \qquad ( 5 )$$

Thus, but for the additional factor of α, Eⱼ in equation (5) is precisely the error term found in (4). Corrected multiple amplitudes for any order can then be recovered according to embodiments by adaptive subtraction of Eⱼ from Qⱼ. One feature of adaptive subtraction, which differentiates it from direct subtraction, is that a data-dependent filter is applied to at least one of the datasets involved, prior to the subtraction. The adaptive subtraction may be defined in such a way as to estimate, then correct for, the scale factor of α found in equations (4) and (5). For example, define the multiple and error equations as:

Q=ΣⱼQⱼ

E=ΣⱼEⱼ

then, in the case where D, Q and E are discretely sampled datasets, for which the k^{th} samples of each dataset are represented by the numbers D^{(k)}, Q^{(k)} E^{(k)} a value of a could be estimated by minimising the cost function, Δ(α), with respect to α, where

$$Δ ( α ) = {\sum }_{k}^{ } {( {D}^{( k )} - \frac{1}{α} ( {Q}^{( k )} - \frac{1}{α} {E}^{( k )} ) )}^{2}$$

This method yields an estimate, α′, of α. Then the amplitude-consistent multiple model, A, can be obtained from the subtraction

$$\underline{A} = \frac{1}{{α}^{′}} ( \underline{Q} - \frac{1}{{α}^{′}} \underline{E} )$$

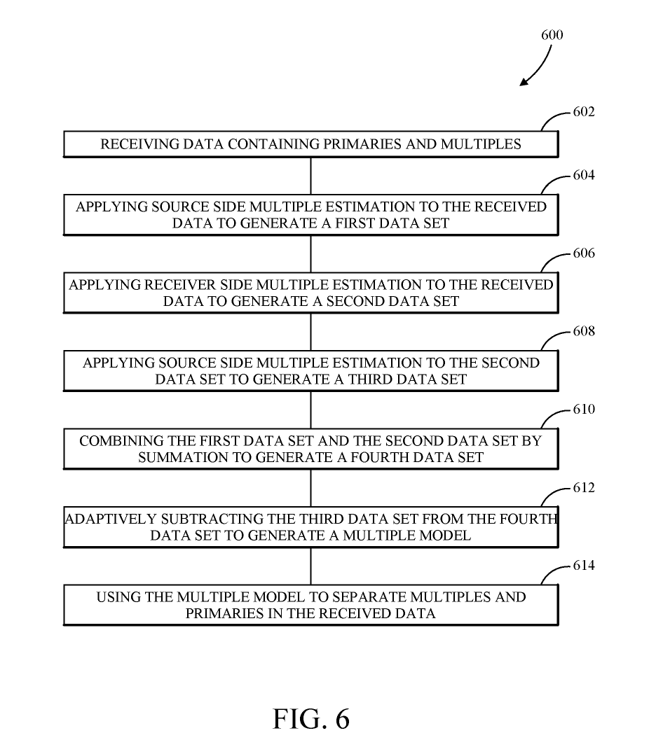

In this example, the method proposed for estimating a constitutes the adaptive nature of the subtraction. However, embodiments are not limited to this specific adaptive subtraction and other adaptive subtractions may be defined. The aforedescribed technique indicates workflows in which an amplitude-consistent MWD model can be obtained, an example of which is provided in the flow diagram of FIG. 6.

It should be noted that the aforedescribed technique addresses only those water-layer multiples associated with a primary reflection from some event deeper than the water bottom. In the case of multiples described by ray paths contained solely in the water layer, an alternative formulation may be applied. For example, this may involve scaling the modelled first order water bottom multiple event by a factor of ½. This has the effect of compensating for the over-estimation of amplitudes associated with the first order water bottom multiple event. Higher orders of water bottom multiple do not require this compensation.

Therein, a method 600 for separating primaries and multiples in data includes receiving 602 data containing primaries and multiples. The data can be collected by generating waves, e.g., acoustic waves, using one or more source devices in an area of interest and receiving reflected wave at receivers, e.g., having sensing elements such as geophones and/or hydrophones or the like using either a land-based or marine-based seismic acquisition system. The data can be recorded and stored for later processing, and it may be raw or partially processed. For example the data may have previously been processed to correct for source designature and/or ghost compensation using other techniques as will be appreciated by those skilled in the art. The input data may have been redatumed based on the depths of the receivers to sea surface using ray tracing or model domain based redatuming. The subsequent multiple model may be corrected back to the datum of the input data prior to subtraction of the multiples. Thus, in the context of FIG. 6, the phrase “receiving data” can refer to the actual acquisition of the data by the acquisition system or it can refer to a data processing system receiving the recorded data as input, or both.

At step 604, a source side multiple estimation technique is applied to the received data to generate a first data set. This can involve, for example, convolving the received data with a source side Green's function, e.g., a multi-dimensional Green's function. Examples of such Green's function are provided below along with the discussion of another embodiment. At step 606, a receiver side multiple estimation technique is applied to the received data to generate a second data set. This can involve, for example, convolving the received data with a receiver side Green's function, e.g., a multi-dimensional Green's function.

At step 608, a source side multiple estimation technique is applied to the second data set to generate a third data set. This can involve, for example, convolving the received data with a source side Green's function, e.g., a multi-dimensional Green's function. The first data set and the second data set are combined at step 610, e.g., by summation, to generate a fourth data set. The third data set is subtracted, e.g., adaptively, from the fourth data set to generate a multiple model at step 612. The multiple model can, for example, be used to separate multiples and primaries in the received data as indicated by step 614. The then multiple attenuated data can be used to generate an image of the subsurface which is explored using the seismic acquisition system.

The foregoing embodiment provides for, among other things, repeated application of the MWD technique to a set of acquired seismic data. Alternatively, a multi-order Green's function (MOGF) can be used to predict an amplitude consistent multiple model using only a single pass of multi-channel convolutions. This may involve a combined source and receiver Green's function modelling operating in the shot and receiver domains simultaneously, for example relating to a first order operator on the receiver side and a second order operator on the source side. Such multi-order Green's functions will now be discussed in the context of another embodiment.

According to an embodiment, a data estimate with reduced multiple content can be derived such that when multiples are added back to the data set, the original data set is recovered. To obtain this reduced multiple data set, one can consider that the original data d consists of primaries p and multiples which are defined by a multi-order Earth response function G, the relationship being expressed as:

d=Gp (6)

where:

G=1+2g+3g²+4g³+ . . . =Σₘ₌₀^{∞}(m+1)g^{m} (7)

and where g is the Earth response operator (e.g. a Primary estimate relating to a Dirac source with no ghost). The Earth response operator is a multiple free estimate of the Earth which is used to generate all associated multiples of all orders. In reality the full Earth response will not be known, and for this reason we may choose one or more reflector pairs responsible for the multiples of interest. This may relate to a Green's function referencing two or more subsurface reflectors which may relate to interbed multiples or peg-leg multiples relating to the free surface and waterbottom or other shallow reflector. The Green's function may be derived from the data itself (e.g. from auto-correlations, imaging or deconvolution operators which may be in one or more dimensions) or from other measurements (e.g. echo-sounder data, well log or analysis of near-field hydrophone data). In the case of interbed multiples, the Green's function may be replaced by a convolution-correlation-convolution operator as described by Jakubowicz, H., 1998, Wave equation prediction and removal of interbed multiples, EAGE expanded abstracts. The Green's functions may have amplitudes relating to the reflectivity of the multiple generators, furthermore the amplitudes may or may not vary with reflection angle. In the case of the water bottom and free surface, this may be considered as:

g=re^{-2πifτ}^{_{g}} (8)

Where r is the Green's function amplitude and τ_{g} relates to the Green's function timing. Note that, in equation (6), while p includes the primary waves, it will also still include some multiple information, e.g., multiples associated with other generators and/or information not contained in the multi-order Earth response/Green's function. Also note that the Green's functions above are associated with the case where the Green's functions on the source side are the same as those on the receiver side. This is not always the case, and a more general formulation is provided below.

The MOGF, such as that illustrated above in equation (7), used in this embodiment can be derived from a single order Green's function representation of a multiple generator, such as that illustrated above in equation (8), with the incorporation of a reflectivity coefficient. The MOGF according to this embodiment is constructed to encode more than one order of multiple such that, when it is convolved with primary data, the result is a dataset including both primaries and multiples. In 1D, the multi-order Green's function, M, may be defined as:

M=Σᵢ_{ₛ}₌₀^{∞}gₛⁱ^{ₛ}Σᵢ_{ᵣ}₌₀^{∞}gᵣⁱ^{^{r}} (9a)

where iₛ and iᵣ index the multiple orders on source and receiver sides respectively, and gₛ, gᵣ are single order Green's functions representing the multiple generators on source and receiver sides, respectively. For consistency, primaries are regarded as multiples of zeroth order. The aforementioned Green's function relates to peg-leg multiples on source and/or receiver sides of a deeper reflection. In the case that the energy relating to an arrival has propagated only within the water-layer, the multi-order Green's function may be given by:

M_{wl}=Σᵢ₌₀^{∞}gⁱ (9b)

where i is the multiple order. In this case we do not distinguish between the source side and receiver side Green's functions. The magnitude of each summand in equations (9a) and (9b) is determined by the reflectivity coefficient of the multiple generator, which will be less than unity. Each sum is therefore bounded, so M and M, are seen to be the product of binomial expansions as given in equations (10a) and (10b):

$$\begin{matrix}M = \frac{1}{( 1 - {g}_{s} ) ( 1 - {g}_{r} )} & ( 10 a ) \\ {M}_{wl} = \frac{1}{1 - g} & ( 10 b )\end{matrix}$$

Ideally the multi-order Green's functions defined by (10a) and (10b) should be applied to different time intervals of data. For example, (10b) should be applied to the water-layer primary event, and (10a) applied to the remainder of the trace. This may be implemented by the following pseudo-code:

a) Receive input data
b) Select energy within a temporal window around the waterbottom timing

### c) Apply MOGF (10b) to (b)

d) Select energy from the tau-p domain trace below the waterbottom timing

### e) Apply MOGF (10a) to (d)

### f) Combine (c) and (e)

An inversion-driven primary estimation scheme is defined for this embodiment, in which the MOGF is used to encode multiples on to an unknown primary model, such that the known seismic data comprising primaries and multiples is recovered, for example in a least squares sense. Working on a frequency slice, the linear equations may be given in the form:

d=L_{g}a (11)

where d is the recorded data including multiples, a is the primary estimate, and L_{g} is a convolution operator encoding the MOGF. The method may be applied with 1D or higher dimension convolutions on source and/or receiver sides. Depending on the number of dimensions employed, the use of higher dimensional convolutions allows the modelling of 2D or 3D multiple generators. Solved with least squares or other inversion, the resulting primary model may be used either directly to estimate primaries in the (x-t) domain or to derive an estimate of the multiples in the (x-t) domain, which can then be subtracted from the input data. Alternatively both primaries and multiples may be output which may be used in combination, e.g. a double adaption strategy as outlined in Mei, Y., and Z. Zou, 2010, A weighted adaptive subtraction for two or more multiple models: 80^{th} Annual International Meeting, SEG, Expanded Abstracts, 3488-3492. Though the system is described here in the context of the frequency domain (after temporal Fourier or other spectral decomposition), according to another embodiment this function can be performed in the time domain. The input itself may be in the x-t domain as described here or in another domain, e.g. tau-p, parabolic radon, hyperbolic radon, curvelet, FK, fx, wavelet transform, high angular complex wavelet domain, SVD, rank reduction, cosine transform, Walsh series, Laplace transform, etc.

The inversion performed in this embodiment can be extended to perform other seismic data processing which involves linear operators at the same time as the multiple modelling. In one embodiment the primary estimate may be derived in a domain different to the input data. In the following discussion the primary estimate is derived in the tau-p domain, although other domains may be used (e.g. FK, curvelet, rank reduction, parabolic Radon, hyperbolic Radon, SVD, ridgelet, contourlet, wavelet, etc.) For example, and assuming a locally 1D multiple generator, the inversion of equation (11) can be extended to include reverse tau-p transform, resignature (see Poole, G., Davison, C., Deeds, J., Davies, K., and Hampson, G., 2013, Shot-to-shot directional designature using near-field hydrophone data, SEG conference proceedings) and receiver reghosting (see Poole, G., 2013, Pre-migration receiver de-ghosting and re-datuming for variable depth streamer data, SEG conference proceedings) functionality as:

d(n)=L(n,m)Lₛ(m)L_{g}(m)a(m) (12)

where a is the unknown τ-p domain primary model, L_{g} is the MOGF convolution operator, Lₛ is the source re-signature operator, and L combines receiver redatuming, reghost and reverse τ-p slant. The trace index of the common shot domain gather is denoted by n, while m indexes the τ-p domain slowness. Where sampling allows, the equations may be defined in 5D primary model space, the τ-pₛₓ-p_{sy}-pᵣₓ-p_{ry} domain, where pₛₓ and p_{sy} are the source side slownesses in the x- and y-directions respectively, pᵣₓ and p_{ry} being the corresponding receiver side slownesses. For marine embodiments with towed streamer acquisition, the dimensionality of the approach may be reduced to T-pₛₓ-pᵣₓ-p_{ry} (3D slownesses on the receiver side, 2D slownesses on the source side.) Alternatively the approach can be simplified by assuming source-receiver ray-path symmetry as described in Poole, G., Cooper, J., King, S., and Wang, P., 2015, 3D source resignature using source-receiver symmetry in the shot tau-px-py domain, EAGE conference proceedings, thus defining the model in the shot τ-pᵣₓ-p_{ry} domain, denoted τ-pᵣₓ-p_{ry} for simplicity.

The linear operators used in equation (12) can be defined as follows, beginning with the receiver reghost and reverse slant term:

L(n,m)=e^{-iωτ}^{_{rxy}}^{(n,m)}(e^{iωτ}^{_{rz}}^{(n,m)}+Se^{-iωτ}^{_{rz}}^{(n,m)}) (13)

τ_{rxy}(n,m)=oₓ(n)pₓ(m)+o_{y}(n)p_{y}(m) (14)

τ_{rz}(n,m)=r_{z}(n)p_{z}(m) (15)

where oₓ and o_{y} are source-receiver offsets in the x and y directions, r_{z} is the receiver depth, and pₓ, P_{y}, and p, are x-, y-, and z-direction slownesses. The first exponential term in equation (13) relates to the reverse slant operator. The subsequent bracketed exponential terms relate to receiver ghost encoding, S being the reflectivity coefficient of the free surface which can, for example, be taken to be equal to −1. In the case that receiver deghosting has already been applied to the data, the reflectivity term, S, may be set to zero. In this case the remaining first bracketed term will relate to redatuming. This may be particularly relevant in the case that the receivers are not on a horizontal datum. The slownesses in each direction are related to the speed of sound in water, v_{w}, by the following expression:

$$\frac{1}{{v}_{w}^{2}} = {p}_{x}^{2} ( m ) + {p}_{y}^{2} ( m ) + {p}_{z}^{2} ( m ) \qquad ( 16 )$$

The source side directional re-signature linear operator term from equation (12) may be expanded as given below:

Lₛ(m)=Σₕ₌₁^{H}[N(h)e^{-iωτ}^{_{syz}}^{(h,m)}(e^{iωτ}^{_{sz}}^{(h,m)}+Se^{-iωτ}^{_{sz}}^{(h,m)}] (17)

τ_{sxy}(h,m)=gₓ(h)pₓ(m)+g_{y}(h)p_{y}(m) (18)

τ_{sz}(h,m)=g_{z}(h)p_{z}(m) (19)

The directional re-signature operators defining Lₛ are calculated by beam forming H notional sources, N(h), which describe the source emission. The gₓ and g_{y} values relate to the notional source positions relative to the center of the source in the x and y directions, respectively, and g_{z} is the notional source depth relative to the sea surface. The bracketed exponential terms define the re-ghosting operator of the notional sources. Note that the re-signature operators may change from shot to shot as described in Poole, G., Davison, C., Deeds, J., Davies, K., and Hampson, G., 2013, Shot-to-shot directional designature using near-field hydrophone data, SEG conference proceedings. The notional sources may have been derived from nearfield hydrophone data or obtained by other means, for example modelling. The notional sources may relate to airgun sources or other sources which may be at the same depth or at a variety of depths. The directional signatures derived in such a way contain source array, airgun response, bubble and ghost energy. This approach combines source resignature and source reghosting to later compensate for source signature and/or ghost in a combined approach. In the case that the source ghost has already been removed from the data, the sea surface reflectivity, S, may be set to zero.

The timing of a single order Green's function for a locally 1D generator, for example relating to the waterbottom, may be given by tau=2zp_{z}, where z is the depth of the generator. This relates to the time difference between an arrival at the receiver and the same arrival at the receiver mirrored about the waterbottom (i.e. a receiver at depth 2z). The Green's function may then be defined by R e^{-2iωzp}^{_{z}} where R is the reflectivity of the generator. The associated slowness-dependent MOGF operator, L_{g}, may be defined with reference to equation (10a) in terms of single order Green's functions as follows:

$${L}_{g} = \frac{1}{( 1 - {R}_{s} {e}^{- 2 iω {z}_{s} {p}_{z}} ) ( 1 - {R}_{r} {e}^{- 2 iω {z}_{r} {p}_{z}} )} \qquad ( 20 )$$

where Rₛ and zₛ are, respectively, the source side water bottom reflectivity and depth, with Rᵣ and Zᵣ the corresponding quantities for the receiver side. A analogous operator may be derived using equation (10b). Application of this approach on data after spatial windowing allows both the reflectivity and the depth of the water bottom to be spatially variant.

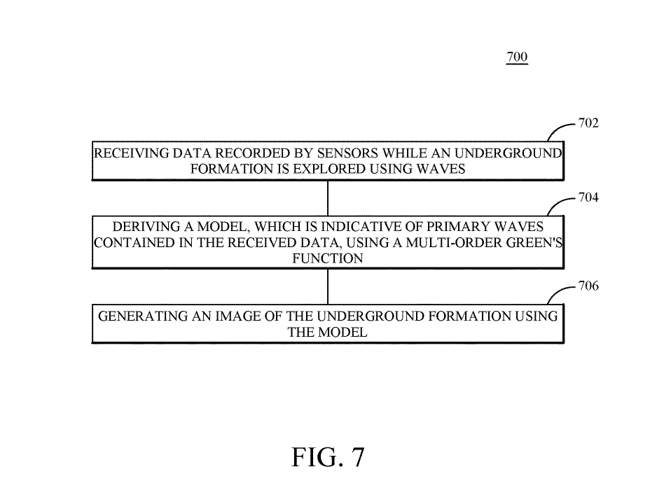

The foregoing, multi-order Green's function embodiments for the processing of seismic data can also be expressed or characterized in other ways. For example, as shown in the flow diagram of FIG. 7, a method 700 includes the step 702 of receiving data recorded by sensors while an underground formation is explored using waves. Like step 602 in FIG. 6; The data can be collected by generating waves, e.g., acoustic waves, using one or more source devices in an area of interest and receiving reflected wave at receivers, e.g., having sensing elements such as geophones and/or hydrophones or the like using either a land-based or marine-based seismic acquisition system. The data can be recorded and stored for later processing, and it may be raw or partially processed. For example the data may have previously been processed to correct for source designature and/or ghost compensation using other techniques as will be appreciated by those skilled in the art. Thus, in the context of FIG. 7, the phrase “receiving data” can refer to the actual acquisition of the data by the acquisition system or it can refer to a data processing system receiving the recorded data as input, or both.

A model is derived, at step 704, which is indicative of primary waves contained in the received data, using a multi-order Green's function as described above. The model is used at step 706 to generate an image of the underground formation.

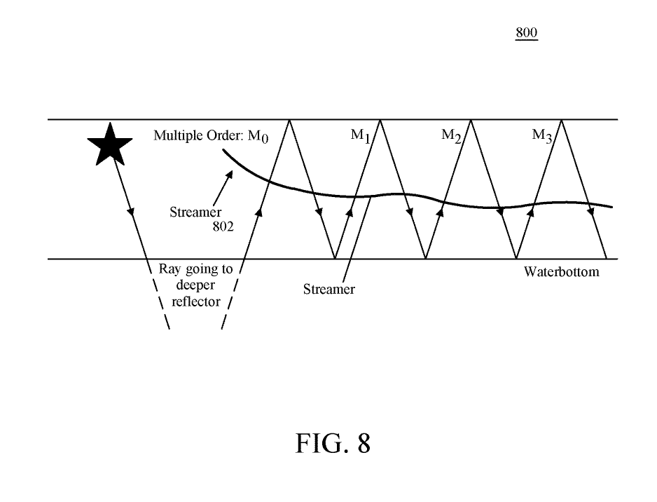

The multiples which are modelled using the embodiment described above may be removed to improve the image generated of the subsurface or, alternatively, they may be used to improve wavefield separation (e.g. source and/or receiver deghosting) or data reconstruction (e.g. redatuming, extrapolation or interpolation) of the data. Consider receiver deghosting, for example, FIG. 8 which illustrates a marine seismic acquisition scenario 800 wherein a variable depth streamer 802 having a plurality of receivers (not shown) disposed therealong is acquiring signal energy from a primary M₀ and a plurality of multiples M₁-M₃ . . . etc. Since the receivers are at different depths, and since the angle of incidence of the multiple wave energy is the same (assuming a flat waterbottom), the multiple recordings will be found on the same trace in the tau-p domain. This enables the multiples' energy to provide notch diversity in the deghosting process. The inversion strategy using combined receiver reg hosting and remultiple derives a ghost free primary model, represented by M₀ For a given reflection recorded by a given receiver this event will be at a fixed depth. The use of the MOGF encodes multiples associated with the primary which will contribute to different receivers relating to a variety of different offsets and receiver depths. This ties the derived primary at a given receiver depth and ghost notch to multiples at different receiver depths. The different receiver depths have different ghost notches. Therefore the derived primary will make use of the notch diversity of the multiples.

In the case of data reconstruction the spatial coordinates (x,y,z) relating to the linear operators may be modified to generate data at output positions different to the input data. This may, for example, include outputting receivers at a shorter offset than those recorded, at a longer offer than those recorded, at receiver locations between streamers, at shot positions in between input shots, at a new cable profile (horizontal, slanted, curved, sinusoidal or another shape), or a combination of the above as desired. The operators may be designed to output the reconstructed data with or without multiples, receiver ghost or source signature as desired. The output positions for data reconstruction may relate to data sampling from another survey, for example a baseline or monitor acquisition relating to a timelapse acquisition.

It should be recognized, for example, that a tau-p model derived with one or more operators in equation (12) may be used to compensate for one or more of deghosting (source and/or receiver), designature, data reconstruction, or demultiple. For example this may include combined source designature, source deghosting, and demultiple. Alternatively it may combine receiver deghosting and demultiple. Any number of the operations may be used in combination. In the case of data reconstruction, this may relate to extrapolation which relates to shot or receiver positions outside the range of those acquired. This may relate to short offsets, long offsets, or receivers outside the spread of the cables (e.g. in the y-direction perpendicular to the nominal cable orientation). Data reconstruction may also relate to interpolation which may be regarded as reconstructing data in between existing sources or receivers. The term ‘in between’ may be taken to refer to receiver (x,y) coordinates intermediate to acquired streamers or receivers. Interpolation or extrapolation may include outputting receivers relating to receiver positions from another survey (e.g. a timelapse project), at positions of streamers from the same survey (e.g. in the case ocean bottom nodes have moved or to correct for streamer feather), or virtual streamers in between existing streamers or on a regular (e.g. nominal) positioning. Data reconstruction may also incorporate a change in the depth of a source and/or receiver. Output data relating to a combination of redatuming and interpolation or redatuming and extrapolation may be implemented. This may relate to outputting on a horizontal datum, slanted datum, BroadSeis datum, sinusoidal datum, slant followed by horizontal or another datum.

Consider the case that all operators were employed for model derivation and we want to perform only receiver deghosting. In this case we may derive the tau-p model using all linear operators, following which we may generate a receiver ghost estimate in the (x-t) domain by applying the linear operators after first setting the first bracketed exponential term in equation (13) to zero. This will generate a dataset of energy containing source signature, multiples, but no up-going energy at the receiver. Subtracting this dataset from the input data would attenuate only receiver ghost energy even though the tau-p model derivation included a re-multiple operation. A similar approach may be used for all embodiments to attenuate up going energy at the receiver to leave only the down going ghost energy which may be combined with any other embodiment described herein. This principle may be extended to other combinations of tau-p model derivation and the final reverse transform from tau-p space to (x-t) domain.

In the case only source deghost and/or designature is required embodiments may, for example, use only the reverse slant and resignature terms in equation (12) which simplifies the equations to be similar to that of Poole, G., Davison, C., Deeds, J., Davies, K., and Hampson, G., 2013, Shot-to-shot directional designature using near-field hydrophone data, SEG conference proceedings. The derived model would then be free of source signature and ghost effects and may then be used, for example, to compensate for directional source ghost and/or signature effects. This may, for example, relate to modifying or attenuating the source ghost and/or source signature. The scheme may optionally be used to modify the source depth (e.g. source redatuming). The scheme may be used to modify a first source emission to a second source emission. For example this may relate to receiving data relating to a first set of notional sources at first depths, deriving the tau-p model, and using the tau-p model to output energy indicative of a second set of notional sources which may or may not be at the same depths as the first notional sources. The notional sources may, for example, change from shot to shot and may relate to a time-lapse project or survey merge. This may relate to a source comprised of elements (e.g. airguns) at a single depth or at more than one depth. The model may be used to combine the energy emitted from source elements at different depths. The solver may be based on linear or non-linear solvers and may use sparseness weights as discussed elsewhere in this document.

In the case of source designature a source correction scheme is now described in more detail. The model may first be used to output all modelled data in the (x-t) domain. This involves applying the same operators in equation (12) that were used for the inversion. Ideally this will recreate the input data, but there will be some differences due to energy which has not been modelled (e.g. dips outside the tau-p dip range or non-coherent noise). The model may also be used to output a second dataset based on the down going energy leaving the source, excluding the bubble. This may relate to use of equation (17) where S=0 and where the notional sources, N, have been truncated to remove bubble energy. The second dataset may relate to the required output, and the first dataset to everything that was modelled. Finally we may calculate the energy to remove from the input data which is the first dataset minus the second dataset. This may be outlined in the following flow:

1) Receive input data
2) Derive a tau-p model with inversion using a re-signature operator and the input data
3) Reverse transform the tau-p model to form an (x-t) dataset indicative of the energy that has been modelled (this, for example, may include source up-going energy, source down-going energy, and bubble)
4) Reverse transform the tau-p model to form an (x-t) dataset indicative of the energy we wish to keep, e.g. the initial impulse (this, for example, may include source down-going energy and no bubble).
5) Calculate energy to remove from recorded data ((3) minus (4))
6) Calculate final output; (1) minus (5).
The scheme described above attempts to remove the source ghost and bubble, however gun response effects will still be present in the data which may be corrected with subsequent application of a shaping filter.

While the above description has focused on source designature, it should be noted that the same scheme may be used for other operators, e.g. demultiple, receiver deghosting, or a combination.

It should be noted that any type of solver may be used to find the model. For example this may be a linear solver, non-linear solver, or hybrid solver. The solver may relate to I2, I1, I0, Cauchy or another norm. Sparseness weights may be derived on low frequencies to dealias energy at high frequencies as described in Herrmann, P., T. Mojesky, M. Magesan, and P. Hugonnet, 2000, De-aliased, high-resolution Radon transforms 70th Annual International Meeting, SEG, Expanded Abstracts, 1953-1956. Sparseness weights may be updated iteratively (commonly known as iteratively re-weighted least squares), or be derived as the model domain is being found. Sparseness weights may be applied in the (x-t) and/or model domain.

The model may also be found by an iterative cleaning method. Examples include the anti-leakage Fourier transform or matching pursuit. This type of solver is intended to cover any method where energy relating to a model parameter is subtracted from the input data before deriving other model parameters. The inversion and iterative cleaning approaches may be combined.

The results may be constrained with data domain weights, model domain weights, or a mixture of data and model domain weights (for example to constrain different data domain samples to be formed from a restrictive model space area). The weights may be time domain, frequency domain, or a mixture of time and frequency domains. The result using any of these schemes may be used to refine the MOGF and the process iterated thereafter.

The input data may be land, towed streamer, OBS (OBN/OBC) or transition zone data. Data may be mono-azimuth, multi-azimuth, wide-azimuth, full azimuth, or another azimuth coverage. The data may relate to one source or more than one source. The sources may fire simultaneously (within a listening time) or independently. For marine acquisition the sources may be on a single vessel or more than one vessel. Towed streamers may be horizontal, slanted, variable depth (BroadSeis), sinusoidal, or another shape. A cable spread of more than one shape may be used. Shapes which begin with a first slope and end with a second slope may be used, e.g. a dipping section followed by a flat section. Data may be input in the shot domain, receiver domain, cross-spread domain, cmp domain, image domain, COV domain, common-offset domain, or another domain. Modifications for OBN datum may be made.

This method is flexible to any type of seismic source. The seismic source may be impulsive or non-impulsive, examples of such sources include impulsive sources such as: dynamite, weight drop, air gun, boomer, sparker, or pinger, and/or non-impulsive such as land vibrator, desynchronized impulsive source array (e.g. ‘popcorn’) or marine vibrator. A mixture of these source types may be deployed within the acquisition.

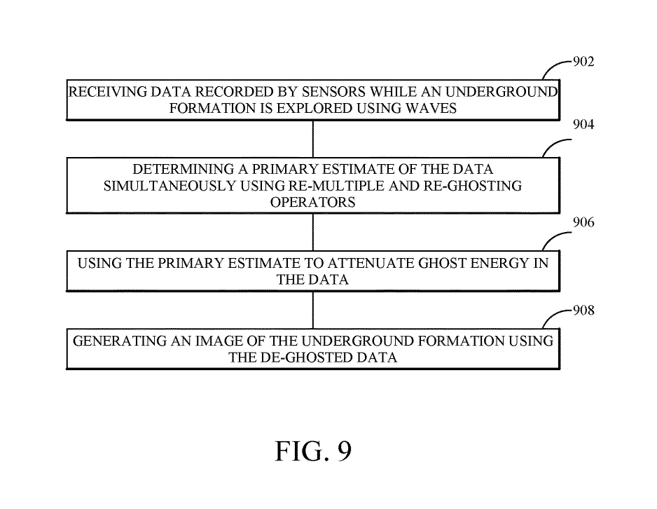

Returning to the recognition that the multiples' energy can be used to provide notch diversity in the deghosting process, this leads to another method embodiment illustrated in the flow diagram of FIG. 9. Therein, the method 900 includes a step 902 of receiving data recorded by sensors while an underground formation is explored using waves. This data is then used to determine a primary estimate of the data simultaneously using re-multiple and re-ghosting operators at step 904, e.g., as described above, and then the determined primary estimate is used to attenuate ghost energy in the data at step 906. An image of the underground formation is generated using the de-ghosted data at step 908.

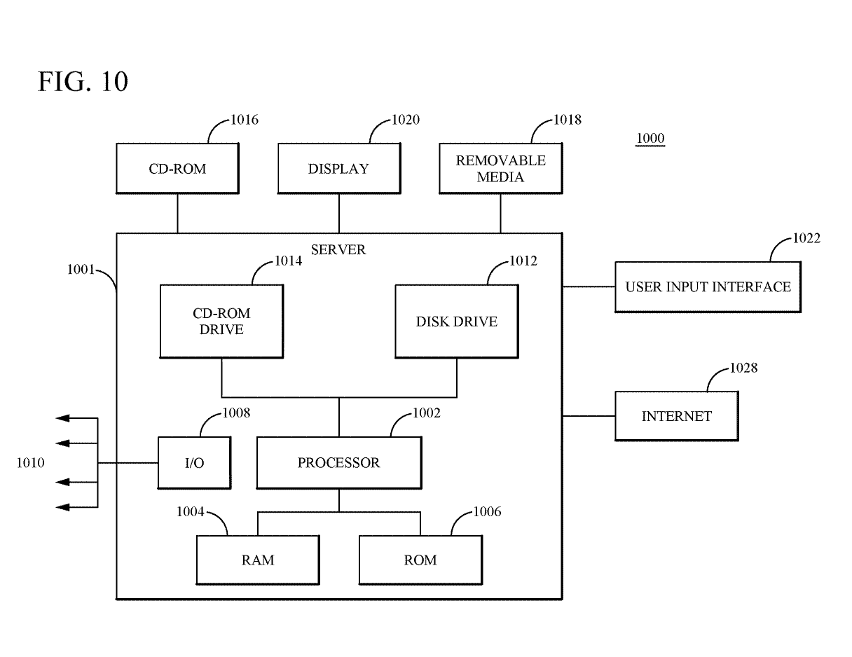

A schematic diagram of a seismic data processing apparatus 1000 configured to perform methods according to various above-discussed embodiments is illustrated in FIG. 10. Hardware, firmware, software or a combination thereof may be used to perform the various steps and operations. Apparatus 1000 may include server 1001 having a data processing unit (processor) 1002 coupled to a random access memory (RAM) 1004 and to a read-only memory (ROM) 1006. ROM 1006 may also be other types of storage media to store programs, such as programmable ROM (PROM), erasable PROM (EPROM), etc. Methods according to various embodiments described in this section may be implemented as computer programs (i.e., executable codes) non-transitorily stored on RAM 1004 or ROM 1006.

Processor 1002 may communicate with other internal and external components through input/output (I/O) circuitry 1008 and bussing 1010. Input-output (I/O) interface 1008 is configured to receive data recorded by sensors while exploring an underground formation using waves, and log data. The waves may be seismic and the log data may include measurements of wave velocity and of density inside the underground formation.

Processor 1002 carries out a variety of functions as are known in the art, as dictated by software and/or firmware instructions. Processor 1002 is configured to obtain a layer model from the log data, the layer model specifying one or more impedance changes inside the underground formation. Processor 1002 is further configured to extract from the data first and later arrivals of the waves emerging from each of the one or more impedance changes. Processor 1002 unit is also configured to estimate at least one of primaries and multiples using one or more of the techniques described above, e.g., by solving an inversion based on a multi-order Green's function.

Server 1001 may also include one or more data storage devices, including disk drives 1012, CD-ROM drives 1014, and other hardware capable of reading and/or storing information, such as a DVD, etc. The input data and results of applying the methods may be stored in these data storage devices. In one embodiment, software for carrying out the above-discussed methods may be stored and distributed on a CD-ROM 1016, removable media 1018 or other forms of media capable of storing information. The storage media may be inserted into, and read by, devices such as the CD-ROM drive 1014, disk drive 1012, etc. Server 1001 may be coupled to a display 1020, which may be any type of known display or presentation screen, such as LCD, plasma displays, cathode ray tubes (CRT), etc. Server 1001 may control display 1020 to exhibit images of the explored subsurface structure generated using first and/or second seismic data. A user input interface 1022 may include one or more user interface mechanisms such as a mouse, keyboard, microphone, touchpad, touch screen, voice-recognition system, etc.

Server 1001 may be coupled to other computing devices, such as the equipment of a vessel, via a network. The server may be part of a larger network configuration as in a global area network such as the Internet 1024, which allows ultimate connection to various landline and/or mobile client/watcher devices.

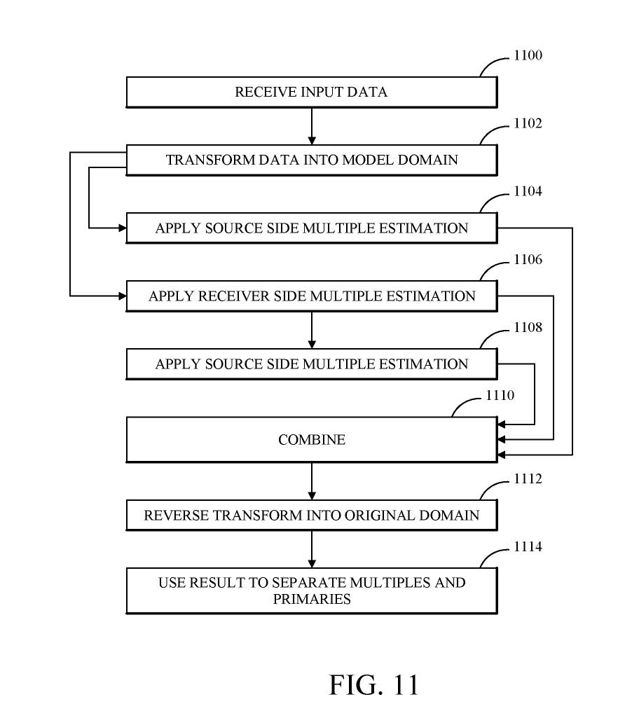

The foregoing embodiments also give rise to various permutations or alternative processing flows, three of which will now be described. First, the seismic data processing techniques described above with respect to FIG. 6 can also be performed in a model domain, e.g., the tau-p domain. Such an embodiment is illustrated in the flow chart of FIG. 11. Therein, at step 1100 the recorded seismic data is received. This data is then transformed into the model domain, e.g., the tau-p domain, at step 1102. Source side and receiver side multiple estimation is applied to the transformed data at steps 1104 and 1106, respectively, to generate first and second data sets. Source side multiple estimation is also applied to the output of step 1106 to generate a third data set at step 1108. All three data sets are combined at step 1110, the result is reverse transformed back into the original domain, e.g., the x-t domain, at step 1112 and the result is used to separate primaries and multiples in the input data. In one embodiment of the aforementioned technique, an operator defined by (gₛ+gᵣ−gₛgᵣ) may be applied to a multi-dimensional frequency domain tau-p model.

A second variant involves separating the different orders of multiples. This may involve first calculating the primary model as described above. Instead of outputting multiples for subtraction from the input data, the primary model may be used to output separate orders of multiple independently. Once the tau-p model has been found, this involves reconstructing data in the x-t domain after replacing L_{g} in equation (12) with a single order Green's function relating to a single order of multiple. The separated orders of multiple may be subtracted with a straight subtraction or adaptive subtraction either separately or with a multi-model adaptive subtraction (e.g. Mei, Y., and Z. Zou, 2010, A weighted adaptive subtraction for two or more multiple models: 80^{th} Annual International Meeting, SEG, Expanded Abstracts, 3488-3492.) Alternatively the datasets for each multiple order may be input to an algorithm designed to migrate multiples. The algorithm may operate on pairs of multiple (e.g. of consecutive order), or on all orders simultaneously. This may be a RTM, beam, CBM, one way wave equation, Kirchhoff or other migration and may be part of a least squares migration scheme.

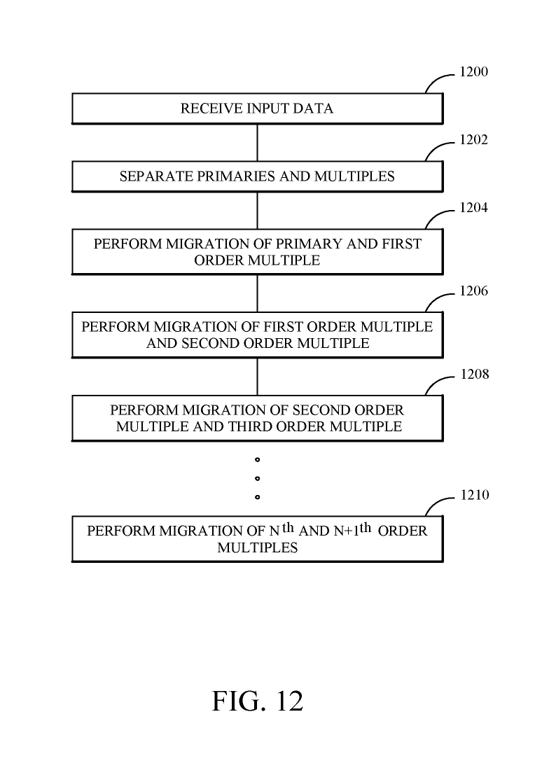

For example, consider the processing flow of FIG. 12. Therein the input data is received at step 1200. Then the primaries and multiples are separated using any of the techniques described above at step 1202. Then a sequential migration of pairs of different order multiples (considering the primary as the zeroth order multiple) can be performed as indicated in steps 1204-1210. This migration can be performed as, for example, described in Liu, Y., X. Chang, D. Jin, R. He, H. Sun, and Y. Zheng, 2010, Reverse time migration of multiples for subsalt imaging: Geophysics, 76(5), WB209-WB216, the disclosure of which is incorporated here by reference.

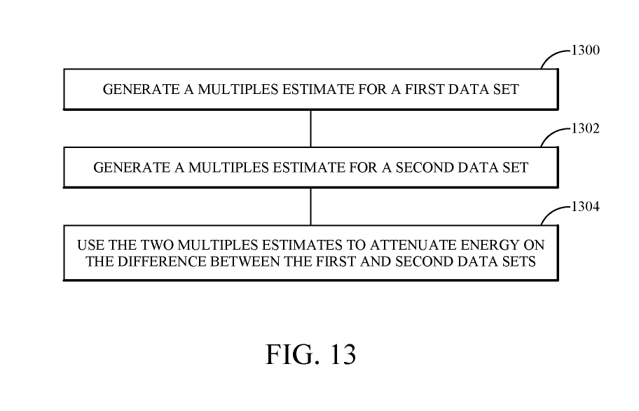

A third variant relates to using separated primary and multiple energy to reduce energy on a difference between a first (e.g. baseline) and second dataset (e.g. monitor), i.e., a so called time-lapse or 4D survey where the same geographical area is surveyed at two different times to, for example, determine depletion of an oil deposit. An example is illustrated in FIG. 13. Therein, at steps 1300 and 1302, multiples estimates are generated from the two datasets recorded from the two surveys using any of the afore-described techniques. Then, at step 1304, the two multiples estimates are used to attenuate energy on the difference between the two datasets. This could involve revising the Green's function to minimize the difference between the timelapse vintages after demultiple. Minimization of energy on the difference section could, for example, relate to finding a minimum in the normalized RMS (NRMS) between the datasets, maximum predictability or a minimum RMS energy on the difference between two datasets. This may be defined over the whole dataset or more commonly within spatial windows. This may relate to a non-linear, e.g. stochastic, inversion approach. This could involve modification of the water depth, water velocity, seabed reflectivity, Green's function wavelet, tidal statics, etc. It would also be possible to use a first vintage relating to a first MOGF to estimate multiples relating to a second vintage with a different MOGF, receiver depth, source signal, etc.

Equation (12) may be optionally modified to add a receiver array operator as described in Poole, G., and Dowle, R., Method for designature of seismic data acquired using moving source, WO 2015/011160. The receiver reghosting term in equation (12) may also be modified to take into account a non-horizontal sea surface. In addition, the method may be used to satisfy multi-sensor data, for example following Poole, G., 2014, Wavefield separation using hydrophone and particle velocity components with arbitrary orientation, SEG conference proceedings. In this case the up-going and down-going contributions to the output data may be scaled based on their direction of propagation (e.g. obliquity correction) which may include a change in polarity of the down-going energy on a vertical accelerometer or geophone relative to that on hydrophone data. It is also possible to derive the model based on one component and use it to estimate energy that would have been recorded on a second component. For example, we may derive a primary model based on hydrophone data and use the model to estimate (x-t) domain data relating to an accelerometer recording. This estimated energy may be used for guided denoise of acquired accelerometer data, e.g. following Poole, G. and Winnett, R, Systems and methods for denoising seismic data, WO 2014/195508.

The method described herein may also be used for noise attenuation. We may consider noise attenuation to cover the suppression of random and/or coherent noise. For example, random noise attenuation may relate to the muting of energy in the model domain (e.g. weak amplitudes unlikely to relate to coherent seismic events of interest) whereas coherent noise suppression may relate to muting of energy in the model domain relating to dips known to correspond to coherent noise, for example cross-talk noise or seismic interference from another source. The source of the noise may also relate to other acquisition noise, examples include bend noise (relating to flexing of streamers, for example when operating in coil shooting mode or cable feather), swell noise, cable strum noise, paravane noise, etc. noise may also relate to external sources, for example drill noise. The strategy may also be used to attenuate shear wave noise, for example following Poole, G., and Grion, S., Device and method for denoising ocean bottom data, US 2013/0163377.

Multiple attenuation based on the method described herein may also be combined with other demultiple strategies, for example Radon demultiple, SRME, deconvolution, MWD, etc.

Additional linear operators may be added to the inversion to account for a difference in sensitivity (e.g. with frequency) between different receivers, or a difference in the bandwidth of output for different sources.

While the method described herein relates to primary estimation, it should be noted that an alternative approach may derive a model of the multiples which through a linear operator models both primaries and multiples. The following embodiment, which is based on equal Green's functions for source and receiver sides, is now described in more detail.

The aforementioned linear operator may be defined as:

d=Ha (21)

Where a is the unknown multiple estimate, in this case in the tau-p domain, H is a linear operator to re-code the primary event in anticipation of the multiples, and d is the input data including primaries and multiples. Based on the notation from equation (10a), we may convert a primary event, p, into multiples of all orders, a, as follows:

$$a = p ( \frac{1}{{( g - 1 )}^{2}} - 1 ) \qquad ( 22 )$$

Combining equations (6) and (7) and recognizing again the binomial expansion as in equation (10a) we find that:

$$d = \frac{1}{{( g - 1 )}^{2}} p \qquad ( 23 )$$

Substituting equation (22) into equation (21) and equating with equation (23) we find:

$$d = Hp ( \frac{1}{{( g - 1 )}^{2}} - 1 ) = \frac{1}{{( g - 1 )}^{2}} p$$

Solving for H results in:

$$H = \frac{1}{2 g - {g}^{2}}$$

which relates to an operator that converts multiples into primaries and multiples. This is equivalent to the following expansion:

$$H = \frac{1}{2} {g}^{- 1} + \frac{1}{4} {g}^{0} + \frac{1}{8} g + \frac{1}{16} {g}^{2} + \frac{1}{32} {g}^{3} + … = {\sum }_{m = - 1}^{∞} \frac{1}{{2}^{m + 1}} {g}^{m}$$

One issue with this, or other approaches, is that it is an infinite series which may compound inaccuracies in the knowledge of g. For this reason it can be attractive to use a series up to m=2 or 3, for example.

While the above discussion related to source and receiver Green's functions being the same, the strategy may be extended to cover the case that source and receiver Green's functions are not equal.

The disclosed embodiments provide methods and apparatus for modeling and separating primaries and multiple reflections. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of exemplary embodiments, numerous specific details are set forth in order to provide a comprehensive understanding of the claimed invention. However, one skilled in the art would understand that various embodiments may be practiced without such specific details.

Equation (12) described linear equations relating to a primary estimate in a model domain to data containing primaries, multiples, source signature, and receiver ghost in the (x-t) domain. It should be noted that the primary estimate may be derived directly in the (x-t) domain following discussion in paragraph [0049]. In the general sense this may relate to a number of linear operations applied in succession, for example:

a) Input reflectivity (UNKNOWN)
b) Iterative convolution to model multiples
c) Convolution with receiver ghost and/or array
d) Convolution with source signature/array and/or ghost
e) Output data (KNOWN)
These linear operators may be applied in any order or combined into a single operation. In the case that the input reflectivity is in the (x-t) domain, step (b) relates to multi-dimensional convolutions and summations, in a similar way to that described in Dragoset, B., Verschuur, E., Moore, I., and Bisley, R. 2010, Geophysics Vol 75, P75A245-75A261. As before, the linear operations may be used as part of an inversion scheme, for example using conjugate gradients where the adjoint sequence of operators may be given by, for example:
a) Input data (KNOWN)
b) Correlate with source signature/array and/or ghost
c) Correlate with receiver ghost and/or array
d) Iterative correlation for multiple orders
e) Output reflectivity (UNKNOWN)
Reghosting may be applied using the application of multi-dimensional filters, or alternatively in a model domain, for example in the FK domain using the following:

$${k}^{2} = {k}_{x}^{2} + {k}_{z}^{2}$$

$$k = \frac{2 π f}{{v}_{w}}$$

$${k}_{z}^{2} = {( \frac{2 π f}{{v}_{w}} )}^{2} - {k}_{x}^{2}$$

$$FK phase shift = {e}^{i {zk}_{z}}$$

Where k is the absolute wavenumber, and kₓ and k_{z} are wavenumbers in the x and z directions respectively. f is the temporal frequency, z is the receiver depth, and v_{w} is the velocity of sound in water. The complex valued phase shift operator is multiplied by each FK element to apply the receiver re-datuming. In our case we apply two phase shifts, one for the cable datum and one for the mirror cable datum as follows:

r=e^{izk}^{_{z}}+Se^{-izk}^{_{z}}

S relates to the water-air interface reflectivity, often taken to be −1. The above formulation is for constant cable depth, z. However, it should be noted that the same scheme may be adopted for varying cable depth. In this case, all FK data are corrected for the depth of each trace independently. Following correction for a trace, the data is reverse k-transformed to the relevant offset. While the above is described in 2D, a similar scheme may be defined in 3D.

It should be noted that reference to (x-t) should be understood to relate to data in the space-time domain, where x may relate to one or more spatial dimensions.

The term source designature may be taken to cover the process of compensating for any combination of: the source emission spectrum (e.g. amplitude variation or emitted energy with frequency; for example airgun effect), zero phasing, directivity relating to the source array, source ghost, source primary and bubble, or another correction. The source designature may be considered as a source signal modification which may remove one or more of the above or modify one or more of the above (for example to match a second survey, e.g. a time-lapse or merge survey). This may include compensating a non-impulsive source emission to an impulsive source emission or the reverse.

The disclosed embodiments provide methods and apparatus for modeling and separating primaries and multiple reflections. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in particular combinations, each feature or element may be usable alone without the other features and elements of the embodiments or in other various combinations with or without other features and elements disclosed herein.

The written description uses examples of the subject matter disclosed to enable any person skilled in the art to practice the same, including making and using the described devices or systems and performing any of the described methods. The patentable scope of the subject matter is defined by the claims, and may include other examples that occur to those skilled in the art. Such examples are intended to be within the scope of the claims.

1. A method comprising:
receiving data recorded by sensors while an underground formation is explored using waves;
deriving a model, which is indicative of primary waves contained in the received data, using a multi-order Green's function; and
generating an image of the underground formation using the model.

2. The method of claim 1, wherein the multi-order Green's function relates to a plurality of Green's function terms, wherein each of the Green's function terms relates to a different order of multiple.

3. The method of claim 2, wherein the number of Green's function terms in the multi-order Green's function is two or three.

4. The method of claim 1, wherein the step of deriving a model using the multi-order Green's function further comprises:
calculating an inversion as: d=Gp
where d is the received data, p includes the primary waves, and G is the multi-order Green's function.

5. The method of claim 1 further comprising:
attenuating multiples using the model and a remultiple operator.

6. The method of claim 1 further comprising:
at least partial separation of up-going and down-going energy in the data using the model and a ghost estimation operator.

7. The method of claim 1, further comprising
performing source deghosting and/or designature of the data using the model and source re-signature operator.

8. The method of claim 1, further comprising:
performing interpolation, extrapolation or re-datum ing of the data using the model.

9. A method comprising:
receiving data recorded by sensors while an underground formation is explored using waves;
determining a primary estimate of the data simultaneously using re-multiple and re-ghosting operators;
using the primary estimate to attenuate ghost energy in the data; and
generating an image of the underground formation using the de-ghosted data.

10. The method of claim 9, wherein the step of determining the primary estimate further comprises:
deriving a model, which is indicative of primary waves contained in the received data, using a multi-order Green's function.

11. The method of claim 10, wherein the multi-order Green's function is a summation including a plurality of Green's function terms, wherein each of the Green's function terms relates to a different order of multiple.

12. The method of claim 11, wherein the number of Green's function terms in the multi-order Green's function is two or three.

13. The method of claim 11, wherein the step of deriving a model using the multi-order Green's function further comprises:
calculating an inversion as: d=Gp
where d is the received data, p are the primary waves, and G is the multi-order Green's function.

14. A data processing apparatus, the apparatus comprising:
an interface configured to receive data recorded by sensors while an underground formation is explored using waves; and
a data processing unit configured to derive a model, which is indicative of primary waves contained in the received data, using a multi-order Green's function; and to generate an image of the underground formation using the model.

15. The apparatus of claim 14, wherein the multi-order Green's function relates to a plurality of Green's function terms, wherein each of the Green's function terms relates to a different order of multiple.

16. (canceled)

17. The apparatus of claim 14, wherein the step of deriving a model using the multi-order Green's function further comprises:
calculating an inversion as: d=Gp
where d is the received data, p includes the primary waves, and G is the multi-order Green's function.

18. The apparatus of claim 14, wherein the data processing unit is further configured to attenuate multiples using the model and a remultiple operator.

19. The apparatus of claim 14, wherein the data processing unit is further configured to reduce free surface ghosts in the data using the model and a ghost estimation operator.

20. The apparatus of claim 14, wherein the data processing unit is further configured to perform source deghosting and/or designature of the data using the model and source re-signature operator.

21. The apparatus of claim 14, wherein the data processing unit is further configured to perform interpolation, extrapolation or re-datum ing of the data using the model.

22-26. (canceled)
